(19) United States
(12) Patent Application Publication
(10) Pub. No.: US 2010/0035001 A1
(43) Pub. Date: Feb. 11, 2010

(54) SEALABLE LAMINATE FOR RECLOSABLE PACKS

(75) Inventors: Christofer Arisandy, Mannheim (DE); Cornelis Petrus Beyers, Altrip (DE); Ines Pietsch, Speyer (DE); Stefan Kirsch, Nieder-Olm (DE); Andree Dragon, Speyer (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/527,698

(22) PCT Filed: Feb. 18, 2008
(86) PCT No.: PCT/EP08/51916

§ 371 Date: Aug. 19, 2009

(30) Foreign Application Priority Data
Feb. 20, 2007 (EP) 07102720.5

(51) Int. Cl. B32B 27/00; B32B 27/30; B32B 7/12; C09J 133/06; B65B 7/00

(52) U.S. Cl. 428/35.2; 428/411.1; 428/457; 428/480; 428/500; 428/463; 53/476

(57) ABSTRACT

A multilayer laminate composed of at least
a) a backing,
b) a pressure-sensitive adhesive layer, and
c) a sealable layer,
   the pressure-sensitive adhesive layer being located between the backing and the sealable layer, and wherein the pressure-sensitive adhesive comprises a polymeric binder having a glass transition temperature of −60 to −0° C. and a gel content of less than 50% by weight (and referred to below for short as adhesive polymer).

The invention relates to a multilayer laminate composed of at least

a) a backing,
b) a pressure-sensitive adhesive layer, and
c) a sealable layer,
the pressure-sensitive adhesive layer being located between the backing and the sealable layer, and wherein the pressure-sensitive adhesive comprises a polymeric binder having a glass transition temperature of −60 to −0° C. and a gel content of less than 50% by weight (and referred to below for short as adhesive polymer).

The invention further relates to the use of this laminate as a constituent of reclosable packs, e.g., as a film lid or tray.

Reclosable packs have been known for some time. With packs of this kind a tray that contains the goods to be packaged is generally sealed durably with a film lid. The sealing layers of the tray and of the film lid are blocking-resistant, i.e., non-tacky. At sufficiently high temperatures they are joined durably to one another (sealing). Opening of the pack exposes a permanently tacky adhesive layer. The permanently tacky adhesive layer ensures repeatable opening and closing of the pack. WO 90/07427, EP-A 1460117, BE 1010387 and DE-A 102005035979 describe reclosable packs which comprise a pressure-sensitive adhesive.

For comestibles, odorless reclosable packs are desired. Polymers which comprise vinyl acetate ought therefore to be avoided as far as possible. For the packaging of comestibles, in addition, chlorine-containing polymers as packaging constituents, such as for a migration barrier, for example, ought as far as possible to be stunned.

The performance properties of the packs ought to be extremely good; in particular, they ought to be able to be opened and sealed firmly again, as far as is possible. Even after repeated opening and closing of the pack, the tackiness of the pressure-sensitive adhesive layer ought to be as far as possible strongly retained.

It was an object of the invention, therefore, to provide odorless reclosable packs, intended not least for comestibles, that have good long-term use properties, not least closeability which remains good even after repeated opening.

Accordingly the laminate defined above was found.

The laminate is composed of

a) a backing,
b) a pressure-sensitive adhesive layer, and
c) a sealable layer,
the pressure-sensitive adhesive layer being located between the backing and the sealable layer.

### The Backing

The backing is for example a polymer film, metal foil, an aluminum foil for example, or metallized polymer films.

The backing may in particular also be a composite of different materials, e.g., of paper and polymer film, polyethylene for example.

Particularly suitable are polymer films, preferably transparent polymer films, or composites of these films with other materials. Examples that may be mentioned include polyolefin films, polyester films or polyacetate films.

Examples of suitable polyolefin films include those of polyethylene or polypropylene, especially oriented polypropylene.

Preference is given to polyester films, such as those of phthalic or terephthalic esters, particular preference being given to films made of polyethylene terephthalate (PET).

The backing may also have been printed, for example.

The thickness of the backing is preferably 1 to 500 μm, more preferably 5 to 200 μm, very preferably 20 to 100 μm.

### The Pressure-Sensitive Adhesive Layer

Applied atop the backing is a pressure-sensitive adhesive (PSA) layer. Between backing and PSA layer there may be further layers, such as migration barriers for gases or water, or adhesion promoters. In one preferred embodiment there is no need for such further layers, and the PSA layer is located directly on the backing.

The PSA that forms the PSA layer preferably comprises no vinyl acetate, either in free form or in copolymerized form.

The PSA comprises a polymeric binder which has a glass transition temperature of −60 to 0° C. and a gel content of less than 50% by weight (referred to below for short as adhesive polymer).

The adhesive polymer preferably comprises no vinyl acetate, either in free form or in copolymerized form.

The glass transition temperature of the adhesive polymer is preferably −60 to −20° C., more preferably −60 to −30° C., and very preferably −60 to −35° C., and in one particular embodiment −50 to −40° C.

The glass transition temperature can be determined by standard methods such as differential thermoanalysis or differential scanning calorimetry (see, for example, ASTM 3418/82, midpoint temperature).

The gel content of the adhesive polymer is preferably less than 40%, in particular less than 35%, and more preferably less than 30% by weight. The gel content may also be 0% by weight, but will generally have a measurable value of between 0 and the maximum limits above.

The gel content is determined in accordance with the following method. 2 g (grams) of the aqueous dispersion are coated onto a backing and dried at room temperature (21° C., 1 bar) for 14 days. 0.5 g of the dry dispersion film obtained is weighed out and then dissolved in 49.5 g of tetrahydrofuran (THF). After 4 days (at 21° C., 1 bar) the fraction that is insoluble in THF is separated off on a 125 μm Perlon filter, dried (21° C., 1 bar) for 24 hours, and weighed. The gel content is the fraction of these insoluble constituents as a percentage of the pre-determined weight of the dried dispersion film.

The adhesive polymer is in particular a polymer obtainable by free-radical polymerization of ethylenically unsaturated compounds (monomers), formed from at least 60% by weight of what are termed principal monomers, selected from C₁ to C₂₀ alkyl (meth)acrylates, vinylaromatics having up to 20 C atoms, ethylenically unsaturated nitriles, vinyl ethers of alcohols comprising 1 to 10 C atoms, aliphatic hydrocarbons having 2 to 8 C atoms and one or two double bonds, or mixtures of these monomers.

The polymer is composed preferably of at least 60%, in particular of at least 80%, and more preferably of at least 90% by weight of the above principal monomers.

Examples include (meth)acrylic acid alkyl esters with a C₁-C₁₀ alkyl radical, such as methyl methacrylate, methyl acrylate, n-butyl acrylate, ethyl acrylate, and 2-ethylhexyl acrylate.

Also suitable in particular are mixtures of the (meth)acrylic acid alkyl esters.

Suitable vinylaromatic compounds include vinyltoluene, o- and p-methylstyrene, o-butylstyrene, 4-n-butylstyrene, 4-n-decylstyrene, and, preferably, styrene. Examples of nitriles are acrylonitrile and methacrylonitrile.

Examples of vinyl ethers include vinyl methyl ether or vinyl isobutyl ether. Preference is given to vinyl ethers of alcohols comprising 1 to 4 C atoms.

As hydrocarbons having 4 to 8 C atoms and two olefinic double bonds mention may be made of butadiene, isoprene, and chloroprene.

Preferred principal monomers are the C₁ to C₁₀ alkyl acrylates and methacrylates, particularly C₁ to C₈ alkyl acrylates and methacrylates, and vinylaromatics, particularly styrene, and mixtures thereof.

Very particular preference is given to methyl acrylate, methyl methacrylate, ethyl acrylate, n-butyl acrylate, n-hexyl acrylate, octyl acrylate, and 2-ethylhexyl acrylate, styrene, and mixtures of these monomers.

In particular the polymer is formed from at least 60%, more preferably at least 80%, and very preferably at least 90% by weight of C₁ to C₂₀ alkyl (meth)acrylates.

In one particular embodiment the adhesive polymer comprises principal monomers having a glass transition temperature below −40° C. and principal monomers having a glass transition temperature greater than 0° C.

The glass transition temperature of a monomer is taken to be the glass transition temperature of the homopolymer as is reported in relevant reference works.

With particular preference the adhesive polymer is composed of at least 60% by weight of C1 to C20 alkyl(meth)acrylates having a glass transition temperature of less than −40° C. and of 0.5% to 30% by weight of C1 to C20 alkyl(meth)acrylates having a glass transition temperature of greater than 0° C., vinylaromatic monomers having a glass transition temperature of greater than 0° C., or mixtures thereof.

With very particular preference the adhesive polymer is composed of at least 60%, in particular at least 80%, by weight of C1 to C20 alkyl(meth)acrylates having a glass transition temperature of less than −40° C. and of 1% to 20%, in particular 2% to 10%, by weight of C1 to C20 alkyl(meth)acrylates having a glass transition temperature of greater than 0° C., vinylaromatic monomers having a glass transition temperature of greater than 0° C., or mixtures thereof.

In particular the adhesive polymer comprises C1 to C20 alkyl(meth)acrylates having a glass transition temperature of greater than 0° C. and vinylaromatic monomers having a glass transition temperature of greater than 0° C.

The weight ratio of the C1 to C20 alkyl(meth)acrylates having a glass transition temperature of greater than 0° C. to vinylaromatic monomers having a glass transition temperature greater than 0° C. can be for example 1:10 to 10:1, more preferably 2:10 to 10:2.

Suitable C1 to C20 alkyl(meth)acrylates having a glass transition temperature of less than −40° C. are, in particular, n-butyl acrylate and 2-ethylhexyl acrylate.

Suitable C1 to C20 alkyl(meth)acrylates and vinylaromatic monomers having a glass transition temperature of greater than 0° C. are, in particular, methyl methacrylate, methyl acrylate, tert-butyl acrylate, butyl methacrylate, and styrene.

Besides the principal monomers the polymer may comprise further monomers, examples being monomers containing carboxylic, sulfonic or phosphonic acid groups (referred to as acid monomers below). Preferred acid monomers are those containing carboxylic acid groups.

By the acid groups, or carboxylic acid groups, are also meant their salts. In the case of the salts, preference is given to the salts with volatile bases, ammonia for example.

Examples that may be mentioned of acid monomers include acrylic acid, methacrylic acid, itaconic acid, maleic acid or fumaric acid.

In one particular embodiment the adhesive polymer comprises acid monomers, in particular in amounts of 0.05% to 5%, more preferably of 0.1% to 3%, by weight based on the adhesive polymer.

Further monomers are, for example, monomers also comprising hydroxyl groups, more particularly C₁-C₁₀ hydroxyalkyl (meth)acrylates, or (meth)acrylamide.

Further monomers additionally include phenyloxyethyl glycol mono(meth)acrylate, glycidyl acrylate, glycidyl methacrylate, and amino (meth)acrylates such as 2-aminoethyl (meth)acrylate.

In one particular embodiment the adhesive polymer comprises monomers comprising hydroxyl groups, more particularly C₁-C₁₀ hydroxyalkyl (meth)acrylates. With particular preference the adhesive polymer is composed to an extent of 0.1% to 10%, more preferably of 0.5% to 5%, and very preferably of 1% to 4% by weight of monomers comprising hydroxyl groups.

Besides the stated monomers the adhesive polymer may also comprise other monomers as well, in amounts for example of 0% to 20%, or 0% to 10% or 0% to 5% by weight. The presence of other monomers, however, is not mandatory, and the amount may therefore, in particular, be 0%.

Particularly preferred adhesive polymers are therefore composed for example of:

60% to 95% by weight of C1 to C20 alkyl (meth)acrylates having a glass transition temperature of less than −40° C.,
0.5% to 30% by weight of C1 to C20 alkyl (meth)acrylates having a glass transition temperature of greater than 0° C., vinylaromatic monomers having a glass transition temperature of greater than 0° C., or mixtures thereof,
0.05% to 5% by weight of acid monomers,
0.1% to 10% by weight of monomers comprising hydroxyl groups, and
0% to 20% by weight of other monomers.

In one preferred embodiment the adhesive polymer is prepared by emulsion polymerization, and the product is therefore an emulsion polymer in the form of an aqueous polymer dispersion.

In the course of the emulsion polymerization ionic and/or nonionic emulsifiers and/or protective colloids or stabilizers are used as surface-active compounds.

A detailed description of suitable protective colloids found in Houben-Weyl, Methoden der organischen Chemie, volume XIV/1, Makromolekulare Stoffe [Macromolecular Compounds], Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are normally below 2000 g/mol. Where mixtures of surface-active substances are used the individual components must of course be compatible with one another, something which in case of doubt can be checked by means of a few preliminary tests. It is preferred to use anionic and nonionic emulsifiers as surface-active substances. Common accompanying emulsifiers are, for example, ethoxylated fatty alcohols (EO units: 3 to 50, alkyl: C₈ to C₃₆), ethoxylated mono-, di- and tri-alkylphenols (EO units: 3 to 50, alkyl: C₄ to C₉), alkali metal salts of dialkyl esters of sulfosuccinic acid, and also alkali metal salts and ammonium salts of alkyl sulfates (alkyl: C₈ to C₁₂), of ethoxylated alkanols (EO units: 4 to 30, alkyl: C₁₂ to C₁₈), of ethoxylated alkylphenols (EO units: 3 to 50, alkyl: C₄ to C₉), of alkylsulfonic acids (alkyl: C₁₂ to C₁₈), and of alkylarylsulfonic acids (alkyl: C₉ to C₁₈).

Further suitable emulsifiers are compounds of the general formula II

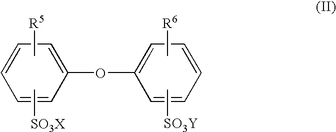

in which R⁵ and R⁶ are hydrogen or C₄ to C₁₄ alkyl but are not simultaneously hydrogen, and X and Y can be alkali metal ions and/or ammonium ions. With preference, R⁵ and R⁶ are linear or branched alkyl radicals having 6 to 18 C atoms or hydrogen, and in particular having 6, 12, and 16 C atoms, R⁵ and R⁶ not both simultaneously being hydrogen. X and Y are preferably sodium, potassium or ammonium ions, sodium being particularly preferred. Particularly advantageous compounds II are those in which X and Y are sodium, R⁵ is a branched alkyl radical having 12 C atoms, and R⁶ is hydrogen or R⁵. Use is frequently made of technical-grade mixtures containing a fraction of from 50 to 90% by weight of the monoalkylated product, an example being Dowfax® 2A1 (trademark of the Dow Chemical Company).

Suitable emulsifiers can also be found in Houben-Weyl, Methoden der organischen Chemie, volume 14/1, Makromolekulare Stoffe, Georg Thieme Verlag, Stuttgart, 1961, pages 192 to 208.

Examples of emulsifier trade names include Dowfax® 2 A1, Emulan® NP 50, Dextrol® OC 50, Emulgator 825, Emulgator 825 S, Emulan® OG, Texapon® NSO, Nekanil® 904 S, Lumiten® I-RA, Lumiten® E 3065, Disponil® FES 77, Lutensol® AT 18, Steinapol VSL, and Emulphor NPS 25.

For the present invention preference is given to ionic emulsifiers or protective colloids. With particular preference they are ionic emulsifiers, in particular salts and acids, such as carboxylic acids, carboxylates, sulfonic acids, and sulfates, sulfonates or carboxylates.

The surface-active substance is typically used in amounts of 0.1 to 10 parts by weight, preferably 0.2 to 5 parts by weight, per 100 parts by weight of the monomers to be polymerized.

Water-soluble initiators for the emulsion polymerization are, for example, ammonium salts and alkali metal salts of peroxodisulfuric acid, e.g., sodium peroxodisulfate, hydrogen peroxide, or organic peroxides, e.g., tert-butyl hydroperoxide.

Also suitable are what are called reduction-oxidation (redox) initiator systems.

The redox initiator systems are composed of at least one, usually inorganic, reducing agent and one organic or inorganic oxidizing agent.

The oxidizing component comprises, for example, the emulsion polymerization initiators already mentioned above.

The reducing components comprise, for example, alkali metal salts of sulfurous acid, such as sodium sulfite, sodium hydrogensulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of customary redox initiator systems include ascorbic acid/iron(II) sulfate/sodium peroxodisulfate, tert-butyl hydroperoxide/sodium disulfite, and tert-butyl hydroperoxide/Na hydroxymethanesulfinate. The individual components, the reducing component for example, may also be mixtures: for example, a mixture of the sodium salt of hydroxymethanesulfinic acid with sodium disulfite.

The compounds stated are mostly used in the form of aqueous solutions, the lower concentration being determined by the amount of water that is acceptable in the dispersion and the upper concentration by the solubility of the respective compound in water. The concentration is generally 0.1% to 30% by weight, preferably 0.5% to 20% by weight, more preferably 1.0% to 10% by weight, based on the solution.

The amount of the initiators is generally 0.1% to 10% by weight, preferably 0.5% to 5% by weight, based on the monomers to be polymerized. It is also possible for two or more different initiators to be used in the emulsion polymerization.

For the polymerization it is possible to use regulators, in amounts for example of from 0 to 0.8 part by weight, per 100 parts by weight of the monomers to be polymerized. These regulators lower the molar mass. Suitable examples include compounds containing a thiol group, such as tert-butyl mercaptan, thioglycolic acid ethyl ester, mercaptoethanol, mercaptopropyltrimethoxysilane, and tert-dodecyl mercaptan.

The emulsion polymerization takes place in general at 30 to 130° C., preferably 50 to 90° C. The polymerization medium may be composed either of water alone or of mixtures of water with water-miscible liquids such as methanol. It is preferred to use just water. The emulsion polymerization may be conducted either as a batch operation or in the form of a feed process, including staged or gradient procedures. Preference is given to the feed process, in which a portion of the polymerization mixture is introduced as an initial charge and heated to the polymerization temperature, the polymerization of this initial charge is begun, and then the remainder of the polymerization mixture is supplied to the polymerization zone, usually by way of two or more spatially separate feed streams, of which one or more comprise the monomers in neat form or emulsified form, this addition being made continuously, in stages or under a concentration gradient, and polymerization being maintained during said addition. It is also possible, in order for example to set the particle size more effectively, to include a polymer seed in the initial charge for the polymerization.

The manner in which the initiator is added to the polymerization vessel in the course of the free-radical aqueous emulsion polymerization is known to the skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

In order to remove the residual monomers it is common to add initiator after the end of the actual emulsion polymerization as well, i.e., after a monomer conversion of at least 95%.

With the feed process, the individual components can be added to the reactor from the top, through the side, or from below, through the reactor base.

In the case of emulsion polymerization, aqueous polymer dispersions with solids contents generally of 15% to 75% by weight are obtained, preferably of 40% to 75% by weight.

For a high reactor space/time yield, dispersions with as high as possible a solids content are preferred. In order to be able to achieve solids contents >60% by weight, a bimodal or polymodal particle size ought to be set, since otherwise the viscosity becomes too high and the dispersion can no longer be handled. Producing a new generation of particles can be done, for example, by adding seed (EP 81083), by adding excess quantities of emulsifier, or by adding miniemulsions. Another advantage associated with the low viscosity at a high solids content is the improved coating behavior at high solids contents. One or more new generations of particles can be produced at any point in time. It is guided by the particle size distribution which is targeted for a low viscosity.

The polymer thus prepared is used preferably in the form of its aqueous dispersion.

The average particle size of the polymer particles dispersed in the aqueous dispersion is preferably 30-1000 nm, in particular less than 750 nm. With particular preference the average particle size is between 100 and 500 nm.

This average particle size is the d₅₀ value of the particle size distribution: that is, 50% by weight of the total mass of all particles have a diameter smaller than the d₅₀ value. The particle size distribution can be determined in a conventional manner using an analytical ultracentrifuge (W. Mächtle, Makromolekulare Chemie 185 (1984), page 1025-39).

The pH of the polymer dispersion is preferably set to a value of more than 4.5, in particular to between 5 and 8.

The polymer dispersion comprises preferably less than 1500 ppm, in particular less than 1000 ppm, more preferably less than 500 ppm of volatile organic compounds TVOC. By TVOC (total volatile organic compounds) are meant all organic compounds having a boiling point of less than 250° C. at 1 bar.

The PSA may be composed solely of the adhesive polymer or of the aqueous dispersion of the adhesive polymer.

The PSA may comprise further additives, e.g., fillers, colorants, flow control agents, thickeners or tackifiers (tackifying resins).

Examples of tackifiers include natural resins, such as rosins and their derivatives formed by disproportionation or isomerization, polymerization, dimerization, hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanetriol, and pentaerythritol.

Also used are hydrocarbon resins, e.g., coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, α-methylstyrene, and vinyltoluene.

Other compounds increasingly being used as tackifiers include polyacrylates which have a low molar weight. These polyacrylates preferably have a weight-average molecular weight M_{w} of less than 30 000. With preference the polyacrylates are composed of at least 60% by weight, in particular at least 80% by weight, of C₁-C₈ alkyl (meth)acrylates.

Preferred tackifiers are natural or chemically modified rosins. Rosins are composed predominantly of abietic acid or its derivatives.

The amount by weight of the tackifiers is preferably 0 to 100 parts by weight, more preferably 0 to 50 parts by weight, per 100 parts by weight of polymer (solids/solids).

Preferably the PSA may comprise flow control agents (e.g., Lumiten), in amounts of 0.05 to 3 parts by weight per 100 parts by weight of polymer, for example.

For use in reclosable packs the PSA must not have too great an internal strength (cohesion). When the pack is first opened, rupture should occur as far as possible in the middle of the PSA layer (cohesive fracture), so that thereafter both the film lid and the tray edge are coated with PSA and, accordingly, the possibility of effective reclosure is ensured.

The adhesive polymer ensures this kind of cohesive fracture.

The cohesion and adhesion of the PSA can be adjusted further through selection of suitable polymers and, if appropriate, suitable additives, more particularly tackifiers, to the desired conditions. For reclosable packs, however, the amount of tackifiers added should preferably be only enough that there is still always a cohesive fracture.

To produce the PSA layer on the backing, the backing material can be coated in typical fashion.

Typical application rates (after drying) are, for example, 1 to 50 g PSA, more preferably 5 to 30 g/m².

### The Sealable Layer

The sealable layer preferably comprises a polymer which at room temperature (21° C., 1 bar) is blocking-resistant, i.e., the polymer film formed is not tacky. With particular preference the polymer is blocking-resistant up to +50° C.

Suitable polymers or polymer systems are all of those which are sealable—that is, the sealing layer formed can be welded—that is, durably joined—to another layer at sufficient pressures and temperatures. This other layer may be composed of the same polymer or of a different polymer.

The sealable layer may be a polymer film which is laminated on as layer c). The sealing layer c) may alternatively be prepared from polymer solutions or polymer dispersions, preference being given to polymer solutions or polymer dispersions in water. The sealable layer can be prepared by filming, and removing the water, from the polymer solutions or polymer dispersions.

The sealable layer c) is preferably composed of a polymer which has been synthesized from at least 20%, more preferably at least 40%, and very preferably at least 60% by weight of an olefin (referred to below for short as polyolefin).

As an olefin mention may be made in particular of ethylene or propylene.

With particular preference the polymer is one which is composed of more than 60% by weight of ethylene.

Suitability is possessed by homopolymers of the olefins, more particularly polyethylene, or polypropylene, or their copolymers with other monomers.

The polymers in question may be low molecular mass homopolymers or copolymers, examples being waxes of the kind described in DE-A 102005035979.

Alternatively they may be high molecular weight polymers, polyethylene for example, which can be processed thermoplastically and can be extruded, for example, in the form of films.

Polyolefins are more particularly sealable with themselves—in other words, the other layer with which a permanent join is to be produced is preferably made of the same material.

The sealable layer may also be composed of polymers which are constructed from the abovementioned monomers of the adhesive polymer; the polymer obtained, however, must be blocking-resistant, being not a PSA. Particularly suitable are the abovementioned (meth)acrylic monomers and vinylaromatic monomers and/or mixtures thereof. Suitable polymers are composed, for example, of more than 60% by weight of (meth)acrylic monomers and vinylaromatic monomers. Under the trade name Joncryl®, aqueous polymer solutions of such polyacrylates, and copolymers of acrylates and styrene, are known which can be used for the sealable layer. The above polymers are suitable in particular for sealing with layers of other polymers, more particularly layers of polyesters, PET for example, polystyrene or polyvinyl chloride.

### The Laminate in General

The laminate can be produced by first coating the backing with the aqueous PSA, which is preferably a PSA dispersion, as set out above.

The preparation of the sealable layer as well can be accomplished by coating with an aqueous polyolefin dispersion, as likewise described in DE-A 102005035979, or, correspondingly, with another polymer solution or polymer dispersion.

In addition, however, the sealable layer may take the form of a polyolefin film and may simply be laminated onto the PSA-coated backing.

The laminate of the invention thus has the following construction, the sequence of the layers corresponding to the three-dimensional arrangement:

a) a backing
b) a PSA layer
c) a sealable layer.

Between the backing and PSA layer on the one hand and between the PSA layer and the sealable layer on the other there may be further layers, examples being layers which form a barrier against unwanted gases (oxygen, water vapor), ensure UV protection, act as oxygen scavengers or protect against migration, or serve as adhesion promoters.

Corresponding layers may also have been applied, for example, on the reverse of the backing.

In particular it is also possible for any desired layers, including for example the facing side or reverse of the backing, to have been printed.

Suitable laminates, however, do not necessarily require any further layers: the PSA layer may have been applied directly to the backing, and the sealable layer may have been applied directly to the PSA layer.

The laminate is suitable as sealable component of reclosable packaging. Packaging of this kind generally consists of a tray and a film lid for the tray.

The laminate of the invention is suitable both as film lid and as tray.

Sealable means that the multilayer laminate (as film lid or tray) can be joined to another substrate. In general such joining (sealing) is performed under elevated pressure and/or temperature, after the product to be packaged has been introduced.

Where the above laminate is used as a film lid, the other substrate is the tray; where the above laminate is used as a tray, the other substrate is the film lid.

In particular the other substrate, at least in those areas where joining to the laminate of the invention is to take place, i.e., at the sealing seam, has an outer coating of the material which is sealable with the sealable layer c) of the laminate, or it is composed of such a material (see the above remarks relating to the sealable layer). Sealing, i.e., the pressing together of the two substrates, is accomplished preferably at a pressure of 1 to 20 bar, more preferably of 1 to 5 bar; the temperature is in particular 30 to 200° C., with particular preference 70 to 120° C., and the duration is in particular 0.5 to 5 seconds, in particular 1 to 2 seconds.

With particular preference the multilayer laminate is used as a film lid, more particularly for the closing of a tray which has a sealing layer composed of a polyolefin.

The multilayer laminate is preferably used for packaging goods, in particular for closing a tray containing the goods.

The products are, in particular, comestibles, examples being meat products, sausage products or cheese products.

The packs produced with the laminate of the invention are reclosable. When the pack is first opened it is the PSA layer that is exposed. Preferably there is cohesive fracture in the PSA layer. The PSA layer does not come apart at one of the interfaces; instead, separation occurs within the PSA layer, so that thereafter the outer faces of both parted substrates are coated with PSA. In this case both surfaces are tacky.

The pack is reclosable a great number of times, with virtually no decrease in strength after repeated closing.

The laminates have a simple layer construction, are odor-free, and are substantially free from volatile constituents. They are suitable for packaging comestibles. There is no need to use chlorinated compounds in the laminates or pack. The pack can be opened and closed a very great number of times, with the capacity for effective reclosure.

### EXAMPLES

All percentages are weight figures, unless specified otherwise. The reporting of a content refers to the content in aqueous solution or dispersion.

Disponil FES 77: 32% strength aqueous solution of the sodium salt of the sulfuric monoester of a C12-C14 alkyl radical ethoxylated with 30 EO units.

Lumiten ISC: aqueous solution of the diethylhexyl ester of sulfosuccinic acid

### Example 1

Solids content: 61.07%
Monomer amount: 604.09 g

| Formula: | | | | | |
|---|---|---|---|---|---|
| Assignment | Amount | | Ingredient | Content | Fraction |
| Initial | Total: 99.15 | g | | | |
| charge | 98.60 | g | DI water | 100.00% | 16.32 |
| | 0.55 | g | Seed T 6772 | 33.00% | 0.03 |
| Addition 1 | Total: 8.55 | g | | | |
| | 4.66 | g | DI water | 100.00% | 0.77 |
| | 3.88 | g | Sodium peroxodisulfate | 7.00% | 0.05 |
| Feed 1 | Total: 749.65 | g | | | |
| | 120.64 | g | DI water | 100.00% | 19.97 |
| | 22.65 | g | Disponil FES 77 | 32.00% | 1.20 |
| | 2.08 | g | Lumiten I-SC | 58.00% | 0.20 |
| | 2.90 | g | Acrylic acid | 100.00% | 0.48 |
| | 11.96 | g | 2-Hydroxypropyl acrylate | 100.00% | 1.98 |
| | 11.96 | g | Styrene | 100.00% | 1.98 |
| | 47.84 | g | Methyl acrylate | 100.00% | 7.92 |
| | 48.45 | g | Methyl methacrylate | 100.00% | 8.02 |
| | 480.97 | g | Ethylhexyl acrylate | 100.00% | 79.62 |
| | 0.19 | g | Terpinolene | 95.00% | 0.03 |
| Feed 2 | Total: 44.87 | g | | | |
| | 44.87 | g | Sodium peroxodisulfate | 7.00% | 0.52 |
| Feed 3 | Total: 56.85 | g | | | |
| | 44.29 | g | DI water | 100.00% | 7.33 |
| | 12.56 | g | Aqueous sodium hydroxide | 25.00% | 0.52 |
| | | | solution | | |
| Feed 4 | Total: 9.06 | g | | | |
| | 9.06 | g | tert-Butyl hydroperoxide | 10.00% | 0.15 |
| Feed 5 | Total: 7.25 | g | | | |
| | 7.25 | g | Rongalit C | 10.00% | 0.12 |

The initial charge was heated to 86° C. in a stirred vessel and at this temperature the polymerization was carried out. First of all addition 1 was introduced and polymerized for 4 minutes. Thereafter feed 1 and feed 2 were commenced and were added over the course of 4 hours. After that feed 3 was added over the course of one hour. Subsequently feeds 4 and 5 were added in parallel in one hour. The dispersion obtained was cooled to room temperature.

### Example 2

### For Comparison

Solids content: 60.00%
Monomer amount: 644.53 g

| Formula: | | | | | |
|---|---|---|---|---|---|
| Assignment | Amount | | Ingredient | Content | Fraction |
| Initial | Total: 98.17 | g | | | |
| charge | 90.23 | g | DI water | 100.00% | 14.00 |
| | 0.98 | g | Seed T 6772 | 33.00% | 0.05 |
| | 6.96 | g | Feed 2 | | 10.00 |
| Feed 1 | Total: 891.91 | g | | | |
| | 226.72 | g | DI water | 100.00% | 35.18 |
| | 15.11 | g | Disponil FES 77 | 32.00% | 0.75 |
| | 5.56 | g | Lumiten I-SC | 58.00% | 0.50 |
| | 6.45 | g | 2-Acrylamido-2- | 100.00% | 1.00 |
| | | | methylpropanesulfonic | | |
| | | | acid | | |
| | 19.34 | g | Styrene | 100.00% | 3.00 |
| | 25.78 | g | Methyl acrylate | 100.00% | 4.00 |
| | 580.08 | g | Ethylhexyl acrylate | 100.00% | 90.00 |
| | 12.89 | g | 2-Hydroxypropyl | 100.00% | 2.00 |
| | | | acrylate | | |
| Feed 2 | Total: 69.61 | g | | | |
| | 64.45 | g | Sodium peroxodisulfate | 7.00% | 0.70 |
| | 5.16 | g | Aqueous sodium hydroxide | 25.00% | 0.20 |
| | | | solution | | |
| Feed 3 | Total: 11.82 | g | | | |
| | 6.45 | g | DI water | 100.00% | 1.00 |
| | 5.37 | g | Acetone bisulfite | 12.00% | 0.10 |
| Feed 4 | Total: 12.89 | g | | | |
| | 6.45 | g | DI water | 100.00% | 1.00 |
| | 6.45 | g | tert-Butyl | 10.00% | 0.10 |
| | | | hydroperoxide | | |

The initial charge was heated to 85° C. in a stirred vessel and the polymerization was carried out at this temperature. First of all a portion of 10% by weight of feed 2 was added. Thereafter feed 1 and feed 2 were commenced. 6% of feed 1 was added over 30 minutes and the remainder of feed 1 over 3 hours. Feed 2 was added over 4 hours. After that feeds 3 and 4 were added in parallel over one hour. The dispersion obtained was cooled to room temperature.

TABLE 1
Composition of the polymers

| | Example 1 | Example 2 |
|---|---|---|
| 2-Ethylhexyl acrylate | 79.62 | 90.00 |
| Methyl methacrylate | 8.02 | — |
| Acrylic acid | 0.48 | — |
| Vinyl acetate | — | — |
| Methyl acrylate | 7.92 | 4.0 |
| Hydroxypropyl acrylate | 1.98 | 2.00 |
| Styrene | 1.98 | 3.00 |
| 2-Acrylamido-2- | — | 1.00 |
| methylpropanesulfonic | | |
| acid | | |
| Terpinolene | 0.03 | — |
| Seed | 0.03 | 0.05 |
| Disponil FES 77 | 1.20 | 0.75 |
| Lumiten ISC | 0.20 | 0.50 |
| Sodium persulfate | 0.52 | 0.70 |
| Gel content | 27% | 61% |
| Tg | −45.9° C. | −61.8° C. |

### Example 3

Used as example 3 was Acronal® V115, a polyacrylate dispersion for PSAs. Acronal V115 was used in the example of DE-A 102005035979 for the production of the laminate, Acronal V115 has a gel content of 56% by weight.

### Pressure-Sensitive Adhesive

The pressure-sensitive adhesive used was the abovementioned polymer dispersions without further additions.

### Production of the Laminate

A polyester film (film 1: polyethylene terephthalate, PET) with a thickness of 36 μm was coated with 17 g/m2 PSA (solids, excluding water) and dried at 90° C. for 3 minutes. The coated film was then laminated with a 25 μm polyethylene film (film 2: polyethylene, PE).

The layer structure of the laminate was therefore as follows:

PET backing
PSA layer
PE sealing layer

### Sealing

### Examples 1 to 3

The laminate was sealed with the PE side of a PET/PE composite film (film 3: thickness 65 μm). The laminate and film 3 were pressed with one another under 3 bar for 3 seconds, film 1 was heated additionally at 145° C., while film 3 was not heated. The sealed composite obtained had a thickness of approximately 10 mm.

The layer structure of the sealed composite was therefore as follows (the sequence indicates the three-dimensional arrangement):

PET backing

### PSA

### PE

### PE

### PET

### Alternative Laminate Option and Sealing

A polyester film (film 1: polyethylene terephthalate, PET) with a thickness of 36 μm was coated with 17 g/m2 PSA (solids, excluding water) and dried at 90° C. for 3 minutes. Thereafter the coated film was coated with a further dispersion (sealing dispersion). The sealing dispersion utilized was a 1:1 mixture of Joncryl® 8211 acrylate dispersion and Joncryl 2648 acrylate copolymer dispersion. 6 g/m² sealing dispersion (solids, excluding water) are coated onto the PSA layer, and drying is carried out at 90° C. for 3 minutes. The dry coating obtained is blocking-resistant (not tacky).

The laminate was then sealed as described above to a PE/PET film (film 3). Alternative options are sealing to a polystyrene film (PS) or a polyvinyl chloride film (PVC).

The layer structure of a sealed composite of this kind is as follows:

PET backing

### PSA

### Film of Joncryl

### PE

### PET

or
PET backing

### PSA

### Film of Joncryl

### PS or PVC

### Overview of Sealed Composites

| PSA from | Gel content % by | Sealing layer of | Sealing layer of |
|---|---|---|---|
| example | weight | the laminate | the other substrate |
| 1 | 27 | PE | PE |
| 2 | 61 | PE | PE |
| 3 | 56 | PE | PE |

### Testing of the Coated Laminate for Reclosability

The sealed composite thus produced was subjected to a separation test. For this test film 3 and the laminate were separated repeatedly with a constant removal speed of 300 mm/minute. Following each separation, film 3 is rebounded to the laminate using a roller device (weight of 2 kg, speed of 10 mm/sec). The table below reports the average force during the constant removal, and the maximum force that occurred, in N/10 mm.

| | | | Example 2 | Example 2 | Example 3 | Example 3 |
|---|---|---|---|---|---|---|
| Number | Example 1 | Example 1 | (comparative) | (comparative) | (comparative) | (comparative) |
| of | average | maximum | average | maximum | average | maximum |
| separations | force | force | force | force | force | force |
| 1 | 7.6 | 8.8 | 3.8 | 4.1 | 4.8 | 5.3 |
| 2 | 1.2 | 1.5 | <0.5 | <0.5 | 0.4 | 0.9 |
| 3 | 1.4 | 1.7 | Breakage | Breakage | 0.5 | 0.8 |
| 4 | 1.5 | 1.7 | | | 0.4 | 0.9 |
| 5 | 1.4 | 1.6 | | | <0.5 | <0.5 |
| 6 | 1.3 | 1.4 | | | Breakage | Breakage |
| 7 | 1.4 | 1.6 | | | | |
| 8 | 1.4 | 1.6 | | | | |
| 9 | 1.2 | 1.4 | | | | |
| 10 | 1.3 | 1.5 | | | | |
| Fracture | C | C | C | C | C | C |
| pattern | | | | | | |

C: Cohesive fracture

1-13. (canceled)

14. A multilayer laminate, comprising:
a) a backing,
b) a pressure-sensitive adhesive layer, and
c) a sealable layer,
wherein the pressure-sensitive adhesive layer is located between the backing and the sealable layer, and wherein the pressure-sensitive adhesive comprises a polymeric binder having a glass transition temperature of −60 to 0° C. and a gel content of less than 50% by weight, wherein the pressure-sensitive adhesive layer is an emulsion polymer.

15. The multilayer laminate according to claim 14, wherein the backing is a transparent polymer film, metal foil or metallized polymer film.

16. The multilayer laminate according to claim 14, wherein the backing is a polyolefin film or polyester film.

17. The multilayer laminate according to claim 14, wherein the backing is a composite of different materials.

18. The multilayer laminate according to claim 14, wherein the pressure-sensitive adhesive layer and the pressure-sensitive adhesive layer comprise no vinyl acetate, either in free form or in copolymerized form.

19. The multilayer laminate according to claim 15, wherein the pressure-sensitive adhesive layer comprises as monomer units at least 60% by weight of C1 to C20 alkyl (meth)acrylates.

20. The multilayer laminate according to claim 14, wherein the pressure-sensitive adhesive layer has a gel content of less than 40% by weight.

21. The multilayer laminate according to claim 14, wherein the sealable layer comprises a polymer which is blocking-resistant at room temperature.

22. The multilayer laminate according to claim 14, wherein the sealing layer is obtainable by lamination with a polymer film or by filming of a polymer solution or polymer dispersion in water.

23. A method of packaging goods in a reclosable pack, wherein a multilayer laminate according to claim 14 is a constituent of the reclosable pack.

24. A reclosable pack comprising a laminate according to claim 14.

25. A method of packaging goods comprising enclosing said goods in a a reclosable pack according to claim 24.
